(19) United States
(12) Patent Application Publication
(10) Pub. No.: US 2021/0300395 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/217,340

(22) Filed: Mar. 30, 2021

(30) Foreign Application Priority Data
Mar. 30, 2020 (JP) 2020-061640

(51) Int. Cl. B60W 50/08; B60W 60/00; B60W 30/06

(52) U.S. Cl. CPC B60W 50/082; B60W 60/0057; B60W 2050/007; B60W 30/06; B60W 60/0053

(57) ABSTRACT

An accommodation area management device that manages an accommodation area capable of accommodating a moving body includes an acquisition unit configured to acquire information indicating an operation state of a user in the moving body, a determination unit configured to determine whether or not an operation change, in which the operation of the moving body is replaced to be performed by the user, is performed, based upon the information indicating the operation state acquired before the moving body exits from the accommodation area, and a processing unit configured to allow the moving body to exit from the accommodation area when it is determined that the operation change is performed.

### CROSS-REFERENCE TO RELATED APPLICATIONS

This application is based upon and claims the benefit of priority from prior Japanese patent application No. 2020-061640, filed on Mar. 30, 2020, the entire contents of which are incorporated herein by reference.

### TECHNICAL FIELD

The present invention relates to an accommodation area management device that manages an accommodation area capable of accommodating a moving body.

### BACKGROUND ART

In a related art, in a vehicle that can be driven both automatically and manually, a technology for safely performing a transition from an automatic driving mode to a manual driving mode is known. For example, WO2017-199575 describes a technology in which an exit of a vehicle-only road is set as an endpoint of the automatic driving mode, and in a time-consuming transition control section at the endpoint thereof, a manual operation of a user is gradually reflected on the operation of the vehicle based upon driving operation reliability of the user.

However, the related art does not sufficiently consider the time when a moving body exits from an accommodation area capable of accommodating the moving body such as a vehicle or the like, and thus, there is room for improvement in this point. For example, after a vehicle capable of performing both automatic driving and manual driving exits from a parking lot where the automatic driving is allowed to travel to a general roadway or the like where a manual operation by a user is required, reliability of allowing the user to smoothly perform the operation is low, and safety cannot be guaranteed.

### SUMMARY OF INVENTION

The present invention provides an accommodation area management device capable of allowing a user to smoothly operate a moving body after the moving body exits from an accommodation area.

According to an aspect of the present invention, there is provided an accommodation area management device that manages an accommodation area capable of accommodating a moving body. The device includes an acquisition unit configured to acquire information indicating an operation state of a user in the moving body, a determination unit configured to determine whether or not an operation change, in which the operation of the moving body is replaced to be performed by the user, is performed, based upon the information indicating the operation state acquired before the moving body exits from the accommodation area, and a processing unit configured to allow the moving body to exit from the accommodation area when it is determined that the operation change is performed.

According to the present invention, since a moving body is allowed to exit from an accommodation area when it is determined that an operation change, in which the operation of the moving body is replaced to be performed by a user, is performed, it is possible to allow the user to smoothly operate the moving body after the moving body exits from the accommodation area.

### BRIEF DESCRIPTION OF DRAWINGS

FIG. 1 is a diagram illustrating an example of a configuration of a vehicle system according to the embodiment;

FIG. 2 is a diagram illustrating an example of a parking lot managed by a parking lot management device;

FIG. 3 is a diagram illustrating an example of a configuration of the parking lot management device:

FIG. 4 is a diagram illustrating an example of a parking space information table; and

FIG. 5 is a flowchart illustrating an example of exit control processing performed by the parking lot management device.

### DESCRIPTION OF EMBODIMENTS

Hereinafter, an embodiment of a parking lot management device of the present invention will be described with reference to the accompanying drawings. The following embodiment will describe an example in which a moving body in the present invention is a vehicle such as the automobile or the like, and an accommodation area in the present invention is a parking lot.

First, a vehicle of the embodiment will be described. The vehicle of the embodiment (hereinafter, also referred to as a vehicle M) is a vehicle including a drive source and wheels (for example, two wheels, three wheels, or four wheels) including a driving wheel driven by the power of the drive source. The drive source of the vehicle M is, for example, an electric motor. Further, the drive source of the vehicle M may be an internal combustion engine such as a gasoline engine or the like, and a combination of the electric motor and the internal combustion engine.

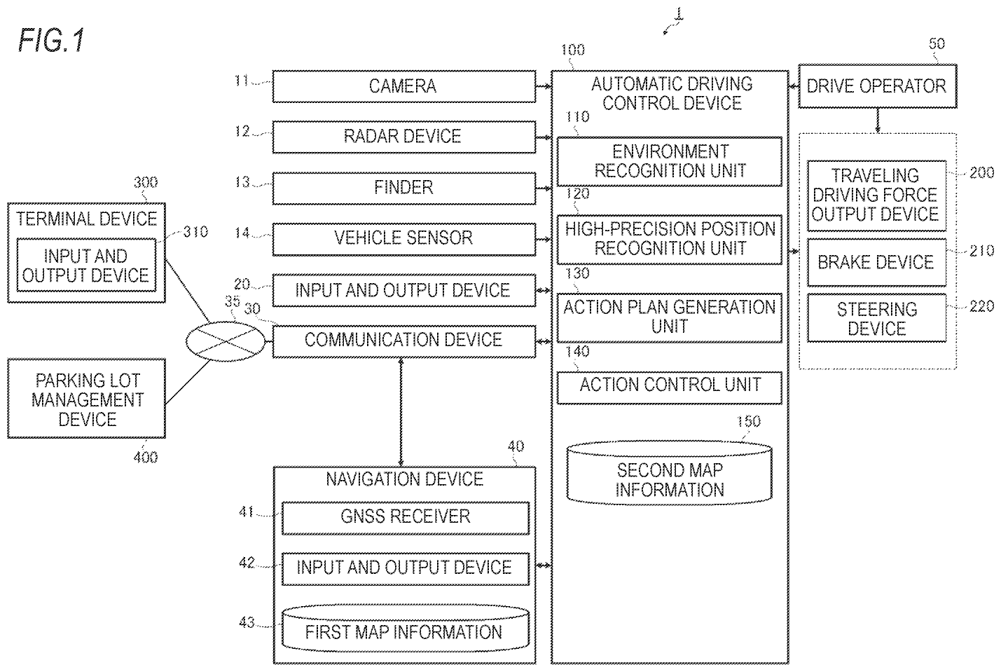

The vehicle M is equipped with a vehicle system 1 illustrated in FIG. 1. The vehicle system 1 has a function capable of performing all driving tasks related to the vehicle M at least in a limited specific area (for example, in a parking lot PA which will be described later). Here, the driving task is, for example, a real-time driving function required for controlling the vehicle M, such as controlling the left-right movement of the vehicle M (steering), controlling the movement in the front-rear direction (acceleration and deceleration), and monitoring the driving environment, and a tactical function such as planning of a traveling track, or the like.

As illustrated in FIG. 1, the vehicle system 1 includes, for example, a camera 11, a radar device 12, a finder 13, a vehicle sensor 14, an input and output device 20, a communication device 30, a navigation device 40, a driving operator 50, an automatic driving control device 100, a traveling driving force output device 200, a brake device 210, and a steering device 220. The respective devices are communicably connected to each other via a wired or wireless communication network. The communication network connecting the respective devices is, for example, a Controller Area Network (CAN).

The camera 11 includes a digital camera that photographs the periphery of the vehicle M (for example, in front of the vehicle M) and a digital camera that photographs the interior of the vehicle M. The camera 11 outputs image data acquired by photographing to the automatic driving control device 100.

The radar device 12 is, for example, a radar device using radio waves in a millimeter wave band, detects a position of an object in the vicinity of the vehicle M (for example, the front, the rear, and the side of the vehicle M), and outputs the detection result thereof to the automatic driving control device 100.

The finder 13 is, for example, a Laser Imaging Detection and Ranging (LIDAR), uses a predetermined laser beam to measure a distance to the object (a target object) existing in the vicinity of the vehicle M (for example, in front of, behind, and to the side of the vehicle M), and outputs the measurement result to the automatic driving control device 100.

The vehicle sensor 14 includes, for example, a vehicle speed sensor that detects the speed of the vehicle M, an acceleration sensor that detects the acceleration of the vehicle M, an angular velocity sensor that detects the angular velocity around the vertical axis of the vehicle M, an orientation sensor that detects the direction of the vehicle M, or the like. Further, the vehicle sensor 14 includes a radio wave intensity sensor that detects the intensity of radio waves (that is, a communication environment) used for communication by the communication device 30. The vehicle sensor 14 outputs the detection result of each sensor to the automatic driving control device 100.

The input and output device 20 includes an output device that outputs various information to a user of the vehicle M (hereinafter, also simply referred to as a user) and an input device that receives various input operations from the user. The output device of the input and output device 20 is, for example, a display that performs displaying based upon the processing result of the automatic driving control device 10. The output device may be a speaker, a buzzer, an indicator light, or the like. Further, the input device of the input and output device 20 is, for example, a touch panel and an operation button (a key, a switch, or the like) that outputs an operation signal corresponding to the input operation received from the user to the automatic driving control device 100.

The communication device 30 is wirelessly connected to a network 35 and communicates with another device provided outside the vehicle system 1 via the network 35. The network 35 is, for example, a mobile communication network, a Wi-Fi network, Bluetooth (registered trademark), Dedicated Short Range Communication (DSRC), or the like.

The communication device 30 communicates with, for example, a terminal device 300 carried by the user of the vehicle M. The terminal device 300 is, for example, a smartphone, or a tablet terminal, and is an electronic device connected to the network 35 and including an input and output device 310. The input and output device 310 is, for example, a display that displays various information to the user, a touch panel that receives the input operation of the user, or the like.

The navigation device 40 includes a Global Navigation Satellite System (GNSS) receiver 41 and an input and output device 42. Further, the navigation device 40 includes a storage device (not illustrated) such as a hard disk drive (hereinafter, also referred to as an HDD), a flash memory, or the like, and first map information 43 is stored in the storage device. The first map information 43 is, for example, information representing a road shape by a link indicating a road and a node connected by the link. Further, the first map information 43 may include information representing the curvature of the road and a Point Of Interest (POI).

The GNSS receiver 41 specifies the latitude and longitude of a point where the vehicle M is positioned as the position of the vehicle M based upon the signal received from a GNSS satellite. Further, the navigation device 40 may specify or correct the position of the vehicle M by an Inertial Navigation System (INS) using the output of the vehicle sensor 14.

The input and output device 42 includes an output device that outputs various information to the user and an input device that receives various input operations from the user. The output device of the input and output device 42 is, for example, a display that performs displaying based upon the processing result of the navigation device 40 (for example, displays a route on the map, which will be described later). Further, the input device of the input and output device 42 is, for example, a touch panel and an operation button (a key, a switch, or the like) that outputs the operation signal corresponding to the input operation received from the user to the navigation device 40. The input and output device 42 may be shared with the input and output device 20.

Although detailed description is omitted, for example, the navigation device 40 determines a route from the position of the vehicle M specified by the GNSS receiver 41 to the destination inputted by the user (hereinafter, also referred to as the route on the map) with reference to the first map information 43. Next, the navigation device 40 guides the determined route on the map to the user by the input and output device 42.

A part or all of the functions of the navigation device 40 may be realized by the terminal device 300. Further, a part or all of the functions of the navigation device 40 may be realized by an external server (a navigation server) capable of communicating with the vehicle system 1 by the communication device 30 or the like.

The driving operator 50 is various operators such as an accelerator pedal, a brake pedal, a shift lever, a steering wheel, a deformed steering wheel, a joystick, and the like. The driving operator 50 is provided with a sensor that detects the amount of the operation or presence or absence of operation on the driving operator 50. The detection result by the sensor of the driving operator 50 is outputted to a part or all of the automatic driving control device 100, the traveling driving force output device 200, the brake device 210, and the steering device 220.

The traveling driving force output device 200 outputs the traveling driving force (torque) for the vehicle M to travel to the driving wheel. The traveling driving force output device 200 includes, for example, an electric motor and an electric motor Electronic Control Unit (ECU) that controls the electric motor. The electric motor ECU controls the electric motor based upon the detection result by the sensor of the driving operator 50 (for example, the accelerator pedal) and control information from the automatic driving control device 100. Further, when the vehicle M includes an internal combustion engine and a transmission as a drive source, the traveling driving force output device 200 may include the internal combustion engine, the transmission, and the ECU that controls the internal combustion engine and the transmission.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor of the brake device 210 based upon the detection result by the sensor of the driving operator 50 (for example, the brake pedal) and the control information from the automatic driving control device 100, and outputs the brake torque in accordance with a braking operation to each wheel.

The steering device 220 includes, for example, a steering ECU and an electric motor. The electric motor of the steering device 220 changes the direction of the steering wheel by, for example, applying a force to a rack and pinion mechanism. The steering ECU drives the electric motor of the steering device 220 based upon the detection result by the sensor of the driving operator 50 (for example, the steering wheel) and the control information from the automatic driving control device 100, and changes the direction of the steering wheel (that is, a steering angle).

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like accessible to each functional unit (for example, the high-precision position recognition unit 120) of the automatic driving control device 100, and second map information 150 is stored in the storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time when the communication device 30 communicates with another device. For example, when the vehicle M enters the parking lot PA, the communication device 30 receives information indicating the vehicle passage in the parking lot PA, a position of each parking space, and the like (hereinafter, also referred to as map information in the parking lot) from the parking lot management device 400. Next, the automatic driving control device 100 updates the second map information 150 to incorporate the received map information in the parking lot into the second map information 150. As a result, the automatic driving control device 100 can specify the position of each parking space PS in the parking lot PA, or the like with reference to the second map information 150.

The environment recognition unit 110 performs sensor fusion processing on the information acquired by a part or all of the camera 11, the radar device 12, and the finder 13, recognizes an object existing in the vicinity of the vehicle M and also recognizes the position of the object. The environment recognition unit 110 recognizes, for example, obstacles, road shapes, traffic lights, guardrails, utility poles, surrounding vehicles (including the traveling status such as the speed, the acceleration, or the like, and parking state), lane marks, pedestrians, or the like, and also recognizes positions thereof.

The high-precision position recognition unit 120 recognizes the detailed position and posture of the vehicle M with reference to the position of the vehicle M specified by the navigation device 40, the detection result by the vehicle sensor 14, the image photographed by the camera 11, the second map information, or the like. The high-precision position recognition unit 120 recognizes, for example, the traveling lane on which the vehicle M is traveling, or recognizes a relative position a posture of the own vehicle with respect to the traveling lane. Further, the high-precision position recognition unit 120 also recognizes, for example, the position of the vehicle M in the parking lot PA, or the like.

The action plan generation unit 130 generates an action plan of the vehicle M. Specifically, the action plan generation unit 130 generates a target track on which the vehicle M will travel in the future as the action plan of the vehicle M. For example, the target track is information represented by arranging points (track points) to be reached by the vehicle M for each predetermined traveling distance (for example, about several [m]). Further, the target track may include information on speed elements such as the target speed, the target acceleration, or the like of the vehicle M at each predetermined time or at each track point. The action plan generation unit 130 generates the action plan, for example, according to an instruction of the parking lot management device 400 received by the communication device 30.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based upon the speed element associated with the target track, or controls the steering device 220 according to a curvature degree of the target track.

The automatic driving control device 100 transmits a detection result by a sensor that detects an operation amount with respect to the traveling driving force output device 200, the brake device 210, and the steering device 220 as information indicating an operation state (hereinafter, also referred to as operation state information) to the parking lot management device 400 via the communication device 30. The operation state information includes information indicating whether or not the user is in a posture of being able to operate the driving operator 50 such as the steering wheel or the like, and, for example, also includes information indicating whether or not the user grips the steering wheel with both hands, whether or not the user steps on the accelerator pedal or the like.

Each functional unit provided in the automatic driving control device 100 is realized, for example, by a Central Processing Unit (CPU) executing a predetermined program (software). Further, a part or all of the functional units of the automatic driving control device 100 may be realized by hardware such as Large Scale Integration (LSI), an Application Specific Integrated Circuit (ASIC), a Field-Programmable Gate Array (FPGA), a Graphics Processing Unit (GPU), or the like, and for example, the storage device for storing the second map information 150 and the high-precision position recognition unit 120 may be realized by a Map Positioning Unit (MPU). Further, a part or all of the functional units provided in the automatic driving control device 100 may be realized by the cooperation of the software and the hardware.

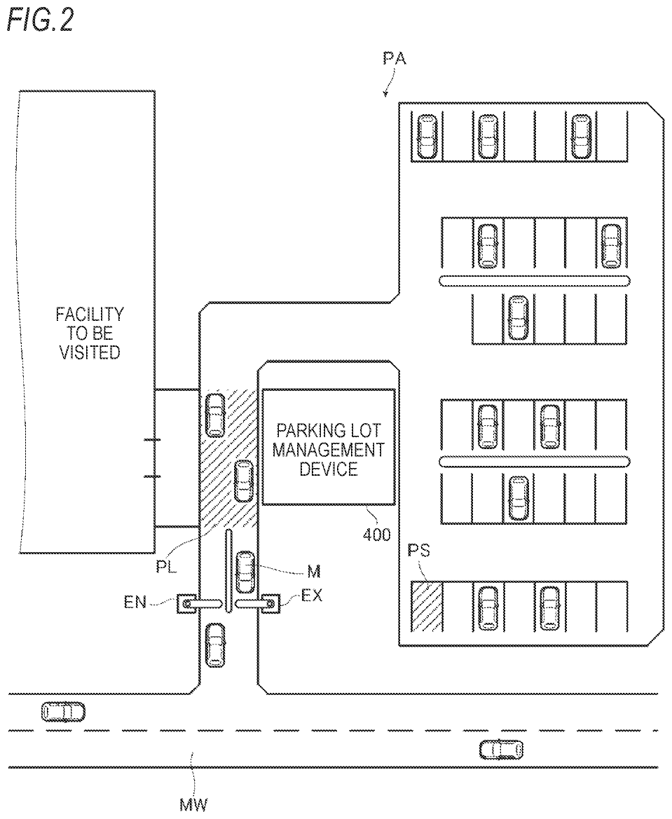

Next, an example of the parking lot PA will be described with reference to FIG. 2. The parking lot PA illustrated in FIG. 2 is an automatic valet parking type parking lot provided as an annex in a visiting facility to be visited by the user and is managed by the parking lot management device 400. The parking lot PA includes a plurality of parking spaces PS capable of accommodating vehicles (for example, the vehicle M), and a platform PL provided in front of the plurality of parking spaces PS. The parking lot PA is an area where the vehicle can automatically travel. In the parking lot PA, the vehicle can travel even in a state where the user gets on the vehicle and even in a state where the user does not get on the vehicle.

An entrance gate EN through which the vehicle passes when entering the parking lot PA, and an exit gate EX through which the vehicle passes when exiting from the parking lot PA are provided in front of the platform PL.

Here, an operation example of the vehicle M, the user, and the parking lot management device 400 when the user of the vehicle M uses the parking lot PA will be described. Before using the parking lot PA, the user of the vehicle M makes a reservation for using the parking lot PA with respect to the parking lot management device 400 that manages the parking lot PA by using the terminal device 300. The “user” is not limited to an owner and a manager of the vehicle M, but includes, for example, a person (for example, a concierge) who performs a procedure such as a parking reservation or the like on behalf of the owner or the like of the vehicle M. For example, the user inputs a date and time of using the parking lot PA and identification information of the vehicle M into the terminal device 300, and transmits the pieces of information to the parking lot management device 400, thereby making a reservation for using the parking lot PA After that, when the date and time of the reservation therefor are reached, the user drives the vehicle M from the entrance gate EN to enter the parking lot PA and arrives at the platform PL. Then, the user gets off from the vehicle M at the platform PL.

After the user gets off the vehicle M, the vehicle M performs automatic driving and starts a self-propelled entry event to move the vehicle M to the parking space PS in the parking lot PA. For example, the user transmits a request for starting the self-propelled entry event to the parking lot management device 400 by using the terminal device 300. In response to the request, the parking lot management device 400 instructs the vehicle M to perform the self-propelled entry event for allowing the vehicle M to be parked in a predetermined parking space PS. According to this instruction, the vehicle M moves to the parking space PS instructed by the parking lot management device 400 while being guided by the parking lot management device 400 and performing sensing by the camera 1, the radar device 12, or the finder 13.

Further, when the vehicle M exits from the parking lot PA, the vehicle M performs the automatic driving and performs a self-propelled exit event to move the vehicle M from the parking space PS to the platform PL. For example, the user transmits a request for starting the self-propelled exit event to the parking lot management device 400 by using the terminal device 300. In response to the request, the parking lot management device 400 instructs the vehicle M to perform the self-propelled exit event to move the vehicle M from the parking space PS where the vehicle M is parked to the platform PL. According to this instruction, the vehicle M moves to the platform PL w % bile being guided by the parking lot management device 400 and performing sensing by the camera 11, the radar device 12, or the finder 13. The user gets on the vehicle M at the platform PL.

After that, the vehicle M performs the automatic driving and heads for the exit gate EX. The parking lot management device 400 invalidates an operation of the user with respect to the vehicle M until the vehicle M reaches the front of the exit gate EX (a predetermined position) from the platform PL. Here, “the front of the exit gate EX” indicates a position immediately before the exit gate EX, that is, a position where a tip of the vehicle M is in a close distance to the exit gate EX.

The parking lot management device 400 does not open the exit gate EX until the vehicle M is permitted to exit (leave) from the parking lot PA. Therefore, the vehicle M automatically stops before the exit gate EX. When the vehicle M stops, the parking lot management device 400 instructs the vehicle M to put the steering wheel in a neutral position. In response to the instruction, the vehicle M puts the steering wheel in the neutral position.

When permitting the vehicle M to exit therefrom, the parking lot management device 400 stops intervention in the driving of the vehicle M and opens the exit gate EX. After the exit gate EX is opened, the vehicle M exits from the parking lot PA by performing manual driving of the user.

Next, the parking lot management device 400 will be described. The parking lot management device 400 is a device (a computer) that manages the parking lot PA. For example, the parking lot management device 400 determines the parking position of the vehicle entering the parking lot PA or instructs the vehicle to move to a determined parking position.

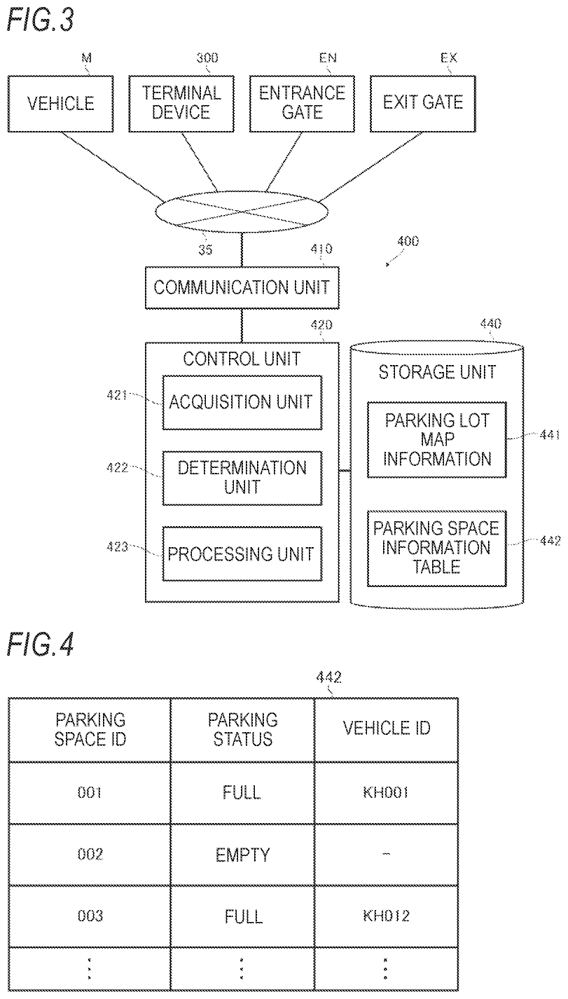

Specifically, as illustrated in FIG. 3, the parking lot management device 400 includes a communication unit 410, a control unit 420, and a storage unit 440. The communication unit 410 and the control unit 420 are realized, for example, by a CPU executing a predetermined program (software) stored in advance. Further, a part or all of these functional units may be realized by hardware such as LSI, ASIC, FPGA, GPU, or the like, or may be realized by the cooperation of the software and the hardware. The storage unit 440 is realized by the HDD, the flash memory, or the like.

The storage unit 440 stores information such as parking lot map information 441, parking space information table 442, or the like. The parking lot map information 441 is information that geometrically represents a structure of the parking lot PA, and includes, for example, information indicating a coordinate (a position) of each parking space PS.

As illustrated in FIG. 4, the parking space information table 442 stores, for example, the information in which a parking space ID, a parking status, and a vehicle ID are associated with each other. Here, the parking space ID is an identifier (identification information) that identifies each parking space PS. The parking status indicates whether there is any vehicle parked in the corresponding parking space PS. For example, if there is any vehicle parked therein, the parking status is set as a “full” status, and if there is no vehicle parked therein, the parking status is set as an “empty” status. The vehicle ID is an identifier of each vehicle as described above. In the parking space information table 442, the vehicle ID is stored in association with the parking space PS of which parking status is in the “full” status, and indicates the vehicle being parked in the parking space PS.

The communication unit 410 communicates with the vehicle M, the terminal device 300, the entrance gate EN, and the exit gate EX wirelessly or by wire (for example, the network 35). The control unit 420 includes an acquisition unit 421, a determination unit 422, and a processing unit 423. The control unit 420 controls an action of the vehicle M based upon the information acquired via the communication unit 410 and the information stored in the storage unit 440.

The acquisition unit 421 acquires the information (the operation state information) indicating the operation state of the user in the vehicle M. Specifically, the acquisition unit 421 acquires, as the operation state information, the information on whether or not the user grips the steering wheel with both hands and the information on whether or not the user steps on the brake pedal. For example, w % ben the vehicle M automatically starts at the platform PL and automatically stops before the exit gate EX, the acquisition of the operation state information by the acquisition unit 421 is performed by communicating with the vehicle M via the communication unit 410. Further, for example, the acquisition of the operation state information may be performed based upon a recognition result or the like using a captured image of a camera (for example, a surveillance camera installed in the parking lot PA) that photographs the vehicle M arriving before the exit gate EX.

The determination unit 422 determines whether or not an operation change in which an operation of the vehicle M is replaced to be performed by the user (hereinafter, also simply referred to as an operation change) is performed, based upon the operation state information acquired before the vehicle M exits from the parking lot PA. Specifically, the determination unit 422 determines whether or not the operation change is performed based upon whether or not the user grips the steering wheel with both hands and steps on the brake pedal.

The processing unit 423 allows the vehicle M to exit from the parking lot PA when it is determined that the operation change is performed. Specifically, the processing unit 423 opens the exit gate EX. At that time, the processing unit 423 displays that the vehicle M is allowed to exit from the parking lot PA on a notification device provided in at least one of a display (not illustrated) installed near the exit gate EX, a display (the input and output device 20 or the like) provided inside the vehicle M, or the like. As a result, the user of the vehicle M can clearly recognize that the vehicle M is allowed to exit from the parking lot PA. Next, when the exit gate EX is opened, the user can drive and operate the vehicle M by himself or herself to exit from the parking lot PA.

As described above, in the embodiment, since the vehicle M is allowed to exit from the parking lot PA only when it is determined that the operation change, in which the operation of the vehicle M is replaced to be performed by the user, is performed, the user can smoothly perform the operation of the vehicle M, that is, the manual driving operation after exiting from the parking lot PA.

Further, in the embodiment, since the exit gate EX is not opened until the vehicle M is allowed to exit from the parking lot PA, the operation change is always performed after the vehicle M stops. As a result, the user can surely recognize the timing of the operation change.

Further, in the embodiment, when the vehicle M stops before the exit gate EX, the steering wheel is put to the neutral position according to the instruction of the parking lot management device 400, and thus, the operation change is always performed when the steering wheel of the vehicle M is in the neutral position. Therefore, it is possible not only to facilitate the operation of the vehicle M by the user after the operation change but also to ensure safety. That is, when the user performs a starting operation of the vehicle M in a state where the steering wheel is not in the neutral position, the vehicle M starts to move toward a left direction or a right direction, which can make the user confused. However, in the embodiment, the operation change is performed on the condition that the steering wheel is in the neutral position, and the starting operation of the vehicle M can be performed, thereby making it possible to improve operability and safety at the time of starting the vehicle M after the operation change.

When the steering device of the vehicle M is the steering wheel, there is a mounting error of the steering wheel, a so-called “play”, or the like. The above-described “neutral position” may be a position in a rotation range of less than 180° to the left and right centering on an actual neutral position. As a result, when the steering wheel is not in the neutral position (that is, not in a straight-ahead state), the user can easily visually recognize that the steering wheel is not in the neutral position, and the position of the steering wheel can be corrected. Further, even in the case of the steering device of the steering wheel, it is preferable to set a range in which the user can easily understand whether the steering device is in the straight-ahead state or not in the straight-ahead state.

Further, in the embodiment, the parking lot management device 400 invalidates the operation of the user on the vehicle M performed before the operation change, such that the parking lot PA can be easily managed.

Further, in the embodiment, the parking lot management device 400 automatically starts the vehicle M after the user gets on the vehicle M at the platform PL, and automatically stops the vehicle M before the exit gate EX (the predetermined position) which is a location slightly away from the platform PL. Next, the parking lot management device 400 acquires the operation state information when the vehicle M stops, and determines whether or not the operation change is performed. Accordingly, it is possible to perform the operation change when the vehicle M automatically stops before the exit gate EX, and the user can perform the operation change at an easy-to-understand timing.

Further, while the embodiment describes an example in which a physical gate (for example, a bar that blocks the passage) is provided as the exit gate EX, such a physical gate may not be provided as the exit gate EX. According to the parking lot management device 400, since the operation of the user on the vehicle M is invalidated from the platform PL to the exit gate EX, it is possible to stop the vehicle M at an appropriate position without providing such a physical gate as the exit gate EX (that is, even if facilities of the parking lot PA are simplified).

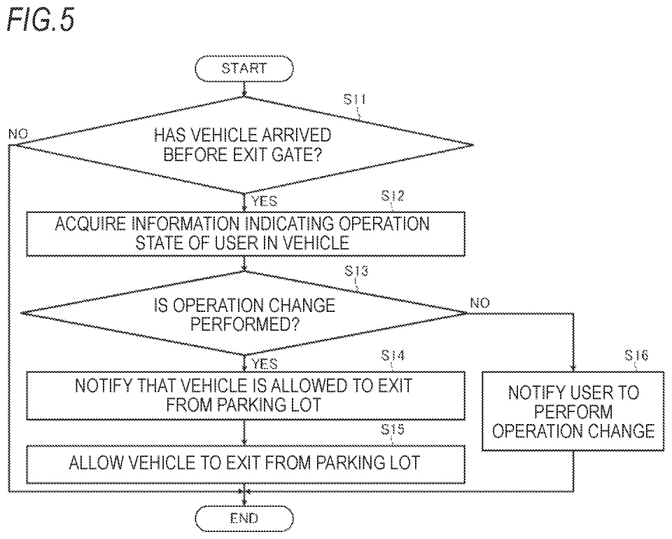

Next, an example of exit control processing performed by the parking lot management device 400 will be described with reference to FIG. 5. The parking lot management device 400, for example, performs the processing illustrated in FIG. 5 at a predetermined cycle.

As illustrated in FIG. 5, the parking lot management device 400 determines whether or not the vehicle M arrives before the exit gate EX (at the predetermined position) (step S11). At this time, the exit gate EX is closed. When it is determined that the vehicle M does not arrive before the exit gate EX (NO in step S11), the parking lot management device 400 ends the processing illustrated in FIG. 5.

When it is determined that the vehicle M arrives before the exit gate EX (YES in step S11), the parking lot management device 400 acquires the information (the operation state information) indicating the operation state of the user in the vehicle M (step S12). Next, the parking lot management device 400 determines whether or not the operation change, in which the operation of the vehicle M is replaced to be performed by the user, is performed based upon the information indicating the operation state of the user in the vehicle M (step S13).

When it is determined that the operation change is performed (YES in step S13), the parking lot management device 400 notifies the user of the vehicle M that the vehicle M is allowed to exit from the parking lot PA (step S14), allows the vehicle M to exit from the parking lot PA (step S15), and, for example, opens the exit gate EX. As a result, the user can smoothly perform the manual driving operation of the vehicle M after exiting from the parking lot PA.

On the other hand, when it is not determined that the operation change is performed (NO in step S13), the parking lot management device 400 does not allow the vehicle M to exit from the parking lot PA (for example, does not open the exit gate EX), notifies the user of the vehicle M to, for example, perform the operation change (step S16), and ends the processing illustrated in FIG. 5. As a result, it is possible to prevent the vehicle M of which operation change to the user is not performed, that is, the vehicle M which is not sufficiently prepared for the manual driving by the user, from exiting from the parking lot PA to a road MW.

The present invention is not limited to the above-described embodiment and can be appropriately modified, improved, or the like. For example, in the above-described embodiment, an example in which the moving body is defined as the vehicle is described, but the present invention is not limited thereto. The idea of the present invention can be applied not only to the vehicle but also to a robot, a ship, an aircraft, or the like which is provided with a drive source and can be moved by the power of the drive source. Further, in the same manner, the accommodation area may be a hangar, a berth, a parking apron (an apron), or the like. Further, automatic driving is a concept that includes autonomous movement.

Further, while the above-described embodiment describes a case in which the exit gate EX is located slightly away from the platform PL, that is, a case in which the platform PL and the exit gate EX are away from each other such that movement of the vehicle M is required to reach the exit gate EX from the platform PL, the exit gate EX may be provided immediately near the platform PL, that is, at a position that can be reached without the movement of the vehicle M. In this case, when the user who gets on the vehicle M at the platform PL grips the steering wheel with both hands and steps on the brake pedal, at that point of time, the driving mode of the vehicle M is switched from the automatic driving to the manual driving. As a result, it is possible to perform the operation change when the user gets on the vehicle M at the platform PL, and the user can perform the operation change at the easy-to-understand timing. Further, as described above, even in this case, the physical gate (for example, the bar) may not be provided as the exit gate EX.

Further, while the above-described embodiment describes an example in which the operation change is performed on the condition that the user grips the steering wheel with both hands and steps on the brake pedal, the operation change may be performed on the condition that the user grips the steering wheel with both hands or the user steps on the brake pedal. Further, the present invention is not limited thereto, and for example, the parking lot management device 400 may determine whether or not the operation change is performed based upon the presence or absence of the operation to terminate an automatic operation function using a touch panel and a predetermined operation button.

Further, in the above-described embodiment, the automatic driving control device 100 recognizes the operation state by the user based upon the detection result by the sensor that detects the operation amount of the driving operator 50. Alternatively or further, the operation state may be recognized based upon an in-vehicle image of the vehicle M captured by the camera 11.

Further, in the above-described embodiment, a fact that the vehicle M is allowed to exit from the parking lot PA is displayed on the display or the like installed near the exit gate EX, and a speaker installed near the exit gate EX, a speaker installed in the vehicle M, or the like may be used to notify the fact.

Further, at least the following items are described in this specification. The components or the like corresponding to the above-described embodiments are shown in parentheses, and the present invention is not limited thereto.

(1) An accommodation area management device (parking lot management device 400) that manages an accommodation area capable of accommodating a moving body (vehicle M), the device including:

an acquisition unit (acquisition unit 421) configured to acquire information indicating an operation state of a user in the moving body:

a determination unit (determination unit 422) configured to determine whether or not an operation change, in which the operation of the moving body is replaced to be performed by the user, is performed, based upon the information indicating the operation state acquired before the moving body exits from the accommodation area; and

a processing unit (processing unit 423) configured to allow the moving body to exit from the accommodation area when it is determined that the operation change is performed.

According to (1), when it is determined that the operation change, in which the operation of the moving body is replaced to be performed by the user, is performed, the moving body is allowed to exit from the accommodation area, and thus, the user can smoothly perform the operation after exiting from the accommodation area.

(2) The accommodation area management device according to (1), where

the operation change is performed after the moving body stops.

According to (2), since the operation change is performed after the moving body stops, the timing of the operation change can be easily guided to the user.

(3) The accommodation area management device according to (2), where

the operation of the user on the moving body performed before the operation change, is invalidated.

According to (3), since the operation of the user on the moving body performed before the operation change is invalidated, the accommodation area management device can easily manage the accommodation area.

(4) The accommodation area management device according to any one of (1) to (3), where

the operation change is performed on the condition that a steering device (steering device 220) of the moving body is in a neutral position.

According to (4), since the operation change is performed on the condition that the steering device of the moving body is in the neutral position, the user can easily operate the moving body after the operation change is performed.

(5) The accommodation area management device according to any one of (2) to (4), where

the accommodation area is an area where the moving body can be automatically moved in a state where the user gets on the moving body and in a state where the user does not get on the moving body, and

the determination unit determines whether or not the operation change is performed based upon the information indicating the operation state acquired at the time when the state changes from the state where the user does not get on the moving body to the state where the user gets on the moving body after the moving body stops.

According to (5), the operation change can be performed when the user gets on the moving body and the user can perform the operation change at an easy-to-understand timing.

(6) The accommodation area management device according to any one of (2) to (4), where

the accommodation area is an area where the moving body can be automatically moved in a state where the user gets on the moving body and in a state where the user does not get on the moving body,

after the state changes from the state where the user does not get on the moving body to the state where the user gets on the moving body, the moving body automatically moves to a predetermined position, and

the determination unit determines whether or not the operation change is performed based upon the information indicating the operation state acquired after the moving body stops at the predetermined position.

According to (6), the operation change can be performed when the moving body automatically stops at the predetermined position and the user can perform the operation change at an easy-to-understand timing.

(7) The accommodation area management device according to any one of (1) to (6), where

when the processing unit allows the moving body to exit from the accommodation area, a notification device (input and output device 20) provided in at least one of the accommodation area and the moving body notifies that the moving body is allowed to exit from the accommodation area.

According to (7), it is possible to notify the user of the moving body that the moving body is allowed to exit from the accommodation area.

What is claimed is:

1. An accommodation area management device that manages an accommodation area capable of accommodating a moving body, the device comprising:
an acquisition unit configured to acquire information indicating an operation state of a user in the moving body;
a determination unit configured to determine whether or not an operation change, in which the operation of the moving body is replaced to be performed by the user, is performed, based upon the information indicating the operation state acquired before the moving body exits from the accommodation area; and
a processing unit configured to allow the moving body to exit from the accommodation area when it is determined that the operation change is performed.

2. The accommodation area management device according to claim 1, wherein the operation change is performed after the moving body stops.

3. The accommodation area management device according to claim 2, wherein
the operation of the user on the moving body performed before the operation change is invalidated.

4. The accommodation area management device according to claim 1, wherein
the operation change is performed on the condition that a steering device of the moving body is in a neutral position.

5. The accommodation area management device according to claim 2, wherein
the accommodation area is an area where the moving body can be automatically moved in a state where the user gets on the moving body and in a state where the user does not get on the moving body, and
the determination unit determines whether or not the operation change is performed based upon the information indicating the operation state acquired at the time when the state changes from the state where the user does not get on the moving body to the state where the user gets on the moving body after the moving body stops.

6. The accommodation area management device according to claim 2, wherein
the accommodation area is an area where the moving body can be automatically moved in a state where the user gets on the moving body and in a state where the user does not get on the moving body,
after the state changes from the state where the user does not get on the moving body to the state where the user gets on the moving body, the moving body automatically moves to a predetermined position, and
the determination unit determines whether or not the operation change is performed based upon the information indicating the operation state acquired after the moving body stops at the predetermined position.

7. The accommodation area management device according to claim 1, wherein
when the processing unit allows the moving body to exit from the accommodation area, a notification device provided in at least one of the accommodation area and the moving body notifies that the moving body is allowed to exit from the accommodation area.
